(19) United States
(12) Patent Application Publication
(10) Pub. No.: US 2020/0236235 A1
(43) Pub. Date: Jul. 23, 2020

(54) INFORMATION PROCESSING SYSTEM, INFORMATION PROCESSING APPARATUS, AND METHOD

(71) Applicant: Yusuke YOSHIOKA, Kanagawa (JP)

(72) Inventor: Yusuke YOSHIOKA, Kanagawa (JP)

(73) Assignee: Ricoh Company, Ltd., Tokyo (JP)

(21) Appl. No.: 16/728,141

(22) Filed: Dec. 27, 2019

(30) Foreign Application Priority Data
Jan. 18, 2019 (JP) 2019-007335

(51) Int. Cl. H04N 1/00

(52) U.S. Cl. CPC H04N 1/00509; H04N 1/00411

(57) ABSTRACT

An information processing system includes a device including a browser; and a service providing system including an information processing apparatus. The service providing system includes a manager configured to manage first flow information of a first flow, second flow information of a second flow associated with the first flow, and parameter setting information; and a provider configured to provide, to the device, flow image screen data based on the first and second flow information, and parameter setting screen data based on the parameter setting information of the first and second flow information. The device includes a renderer configured to display a flow image screen based on the flow image screen data and to display a parameter setting screen based on the parameter setting screen data, and accept, from a user at the parameter setting screen, an operation for setting the parameter of the first and second flow information.

### CROSS-REFERENCE TO RELATED APPLICATION

The present application is based on and claims priority under 35 U.S.C. § 119 to Japanese Patent Application No. 2019-007335, filed on Jan. 18, 2019, the contents of which are incorporated herein by reference in their entirety.

### BACKGROUND OF THE INVENTION

### 1. Field of the Invention

The present invention relates to an information processing system, an information processing apparatus, and a method.

### 2. Description of the Related Art

In recent years, services, etc., for combining a plurality of functions (e.g., scanning, printing, e-mail delivery, etc.) and providing the combined plurality of functions, have become known. For example, there is known a service, etc., for performing a predetermined process on an electronic file (image file) generated by scanning, and delivering the processed file by e-mail. Such a service is implemented by executing one or more processes that implement each function as a series of processes.

For example, there is known a technique that enables easy setting of parameters of an application, from a user interface. In such an application, a flow is set, which defines one or more processes that are executed as a series of processes for implementing each function (see, for example, Patent Document 1).

Patent Document 1: Japanese Unexamined Patent Application Publication No. 2018-14079

### SUMMARY OF THE INVENTION

According to one aspect of the present invention, there is provided an information processing system including at least one device including a browser; and a service providing system including at least one information processing apparatus, wherein the service providing system includes a flow information manager configured to manage, for each application that executes a series of processes using electronic data, first flow information defining an order of executing one or more programs configured to execute each process included in the series of processes of a first flow, second flow information defining an order of executing the one or more programs configured to execute each process included in the series of processes of a second flow associated with the first flow, and parameter setting information for setting a parameter used for executing each of the one or more programs; and a user interface provider configured to provide, to the at least one device, flow image screen data based on the first flow information and the second flow information, and parameter setting screen data based on the parameter setting information of the first flow information and the second flow information, and wherein the at least one device includes a screen renderer configured to display a flow image screen based on the provided flow image screen data and to display a parameter setting screen based on the provided parameter setting screen data, and accept, from a user at the parameter setting screen, a setting operation for setting the parameter of the first flow information and the second flow information.

### BRIEF DESCRIPTION OF THE DRAWINGS

FIG. 1 is a diagram illustrating an example of system configuration of an information processing system according to a first embodiment of the present invention;

FIG. 2 is an example of a hardware configuration diagram of a computer according to the first embodiment of the present invention;

FIG. 3 is a diagram illustrating an example of a hardware configuration of a Multifunction Peripheral (MFP) according to the first embodiment of the present invention;

FIG. 4 is a diagram illustrating an example of a functional configuration of the information processing system according to the first embodiment of the present invention;

FIG. 5 is a diagram illustrating an example of a flow set in a scan translation application according to the first embodiment of the present invention;

FIG. 6 is an image diagram illustrating an example of a flow setting screen according to the first embodiment of the present invention;

FIG. 7 is an image diagram illustrating an example of a flow creation screen according to the first embodiment of the present invention;

FIG. 8 is an image diagram illustrating an example of a component selection screen according to the first embodiment of the present invention;

FIG. 9 is an image diagram illustrating an example of a parameter setting screen according to the first embodiment of the present invention;

FIG. 10 is an image diagram illustrating an example of a parameter order setting screen of the scan translation application according to the first embodiment of the present invention;

FIG. 11 is an image diagram illustrating an example of a preview screen of the scan translation application according to the first embodiment of the present invention;

FIG. 12 is a sequence diagram illustrating an example of a flow display process according to the first embodiment of the present invention;

FIG. 13 is an image diagram illustrating an example of a component selection screen according to another embodiment of the present invention;

FIG. 14 illustrates an example of a component with a check mark according to another embodiment of the present invention; and

FIG. 15 is an image diagram illustrating an example of a parameter order setting screen of the scan translation application according to another embodiment of the present invention.

### DETAILED DESCRIPTION OF THE PREFERRED EMBODIMENTS

In the prior art described above, when another flow is called (e.g., a called flow) from a flow (e.g., a main flow) set in the application, it has not been possible to set the parameters of the other flow on the user interface.

A problem to be addressed by an embodiment of the present invention is to provide an information processing system that enables the setting of parameters of a second flow that is associated with a first flow.

Hereinafter, embodiments of the present invention will be described in detail with reference to the drawings.

### First Embodiment

### <System Configuration>

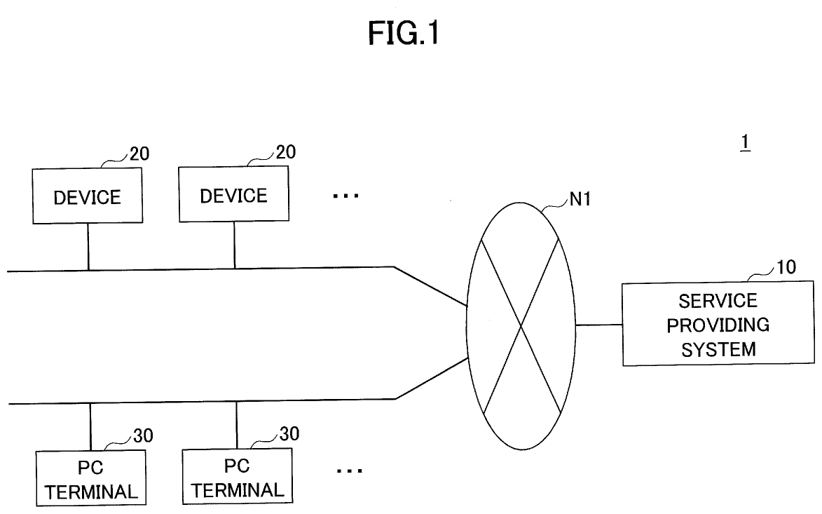

First, the system configuration of an information processing system 1 according to the present embodiment will be described with reference to FIG. 1. FIG. 1 is a diagram illustrating an example of a system configuration of the information processing system 1 according to the present embodiment.

The information processing system 1 illustrated in FIG. 1 includes a service providing system 10, a device 20, and a personal computer (PC) terminal 30, which are communicably connected to each other via a wide-area network N1 such as the Internet.

The service providing system 10 is implemented by one or more information processing apparatuses, and provides, via the network N1, various services implemented by a series of processes formed by combining one or more processes among a plurality of processes respectively implementing various functions. Here, a function is a function related to electronic files, such as document files and image files, and includes printing, scanning, facsimile (fax) transmission, data format conversion, e-mail transmission, processing, compression and decompression, repository storage, Optical Character Recognition (OCR) execution, text translation, file uploading, and the like. A specific example of a service provided by the service providing system 10 according to the present embodiment will be described later. Note that in the following, a series of processes is also referred to as a “flow”.

The device 20 may be various kinds of electronic devices used by the user. The device 20 is, for example, an image forming apparatus. Image forming apparatuses include a Multifunction Peripheral (MFP), a printer, a scanner, a fax machine, and the like.

The device 20 is not limited to an image forming apparatus, as long as a communication function is provided. The device 20 may be, for example, a Projector (PJ), an IWB (Interactive White Board; and a whiteboard having a function of an electronic blackboard capable of mutual communication), an output device such as a digital signage, a Head Up Display (HUD) device, an industrial machine, an imaging device, a sound collector, a medical device, a network home appliance, an automobile (Connected Car), a notebook PC, a mobile phone, a smartphone, a tablet terminal, a game machine, a Personal Digital Assistant (PDA), a digital camera, a wearable PC, a desktop PC, and the like. The user can use various services provided by the service providing system 10 by using the device 20.

The PC terminal 30 is an example of an information processing terminal operated by a user. The PC terminal 30 may be, for example, a notebook PC, a desktop PC, a wearable PC, a mobile phone, a smartphone, a tablet terminal, a game machine, a PDA, and the like. The user can use various services provided by the service providing system 10 by using the PC terminal 30.

The configuration of the information processing system 1 illustrated in FIG. 1 is an example. For example, the information processing system 1 according to the present embodiment may include various devices that perform at least one of inputting and outputting electronic data, and these devices may use various services provided by the service providing system 10. Further, the service providing system 10 may be implemented by being divided across a plurality of computer systems.

### <Hardware Configuration>

### (Computer)

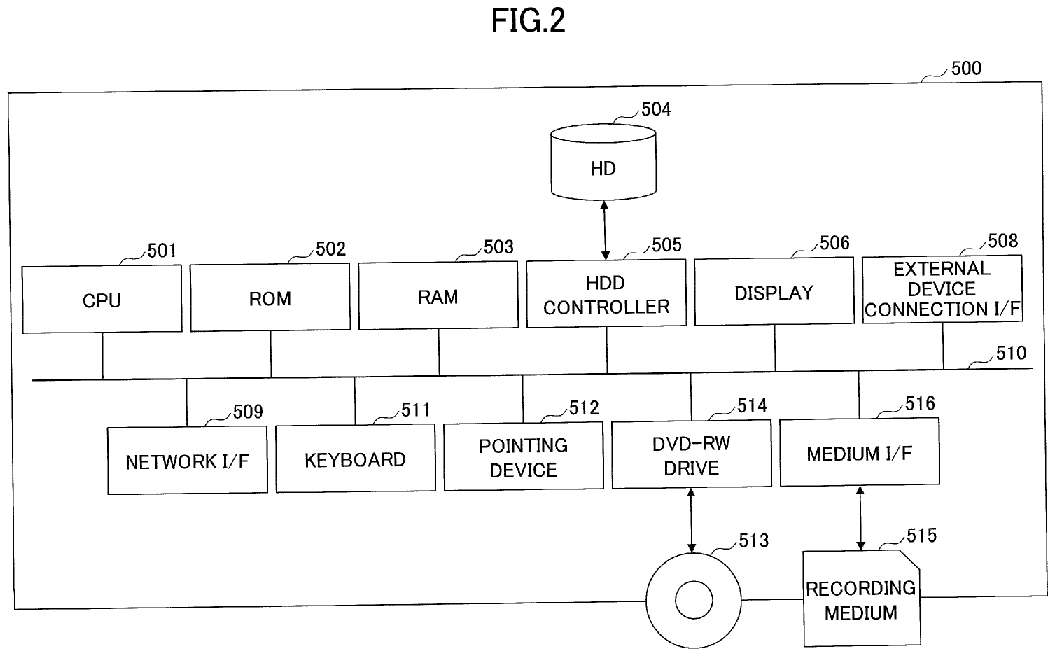

The service providing system 10 and the PC terminal 30 are implemented, for example, by a computer 500 having a hardware configuration illustrated in FIG. 2. Further, when the device 20 is a PC, for example, the device 20 is implemented by the computer 500 having the hardware configuration illustrated in FIG. 2.

FIG. 2 is an example of a hardware configuration diagram of the computer 500 according to the present embodiment. As illustrated in FIG. 2, the computer 500 includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, a Digital Versatile Disc Rewritable (DVD-RW) drive 514, and a medium I/F 516.

Among these, the CPU 501 controls the operations of the entire computer 500. The ROM 502 stores a program used to drive the CPU 501, such as an initial program loader (IPL). The RAM 503 is used as the work area of the CPU 501. The HD 504 stores various kinds of data such as programs. The HDD controller 505 controls the reading or writing of various kinds of data with respect to the HD 504 according to the control of the CPU 501.

The display 506 displays various kinds of information such as a cursor, menus, windows, characters, images, and the like. The external device connection I/F 508 is an interface for connecting various external devices. In this case, the external device may be, for example, a Universal Serial Bus (USB) memory, a printer, and the like. The network I/F 509 is an interface for performing data communication using the network N1. The data bus 510 is an address bus, a data bus, and the like for electrically connecting the elements such as the CPU 501 and the like.

Further, the keyboard 511 is a type of input means with a plurality of keys for inputting characters, values, various instructions, and the like. The pointing device 512 is a type of input means for selecting and executing various instructions, selecting a processing target, moving a cursor, and the like. The DVD-RW drive 514 controls the reading or writing of various kinds of data with respect to a DVD-RW 513 as an example of a removable recording medium. Note that the removable recording medium is not limited to a DVD-RW, but may be a Digital Versatile Disc-Recordable (DVD-R), etc. The medium I/F 516 controls the reading or writing (storage) of data with respect to a recording medium 515, such as a flash memory.

### (Device)

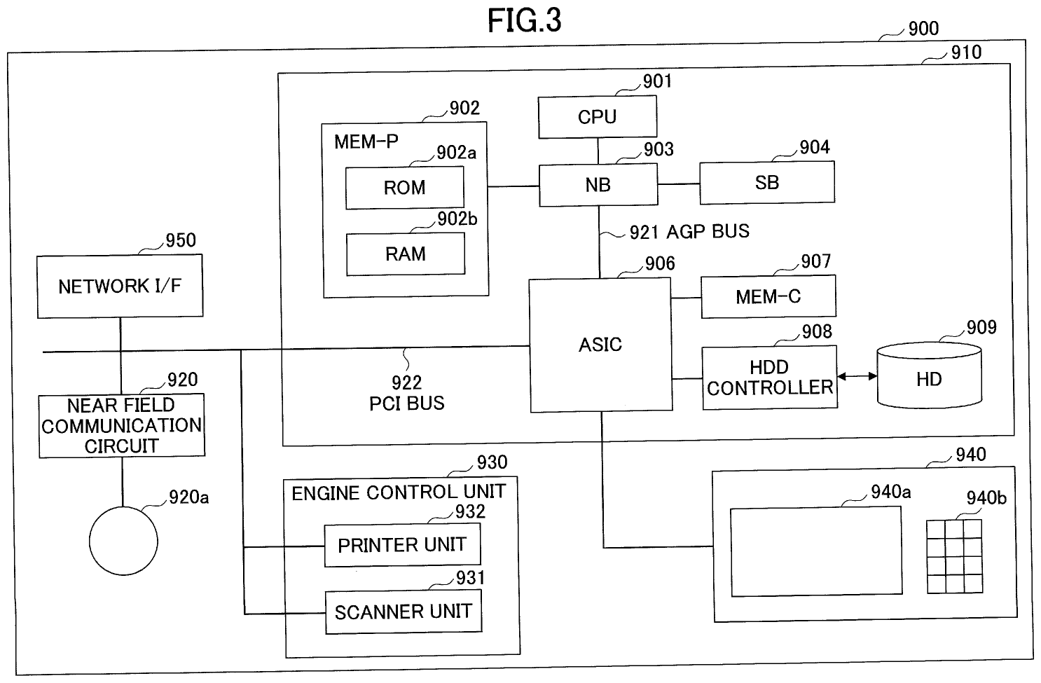

The hardware configuration when the device 20 included in the information processing system 1 is an MFP is illustrated in FIG. 3, for example. FIG. 3 is an example of a hardware configuration diagram of an MFP 900 according to the present embodiment. As illustrated in FIG. 3, the MFP (Multifunction Peripheral/Product/Printer) 900 includes a controller 910, a near field communication circuit 920, an engine control unit 930, an operation panel 940, and a network I/F 950.

Among these, the controller 910 includes a CPU 901 as the main part of the computer, a system memory (MEM-P) 902, a north bridge (NB) 903, a south bridge (SB) 904, an Application Specific Integrated Circuit (ASIC) 906, a local memory (MEM-C) 907 that is a storage unit, a HDD controller 908, and a HD 909 that is a storage unit. The NB 903 and the ASIC 906 are connected by an Accelerated Graphics Port (AGP) bus 921.

Among these, the CPU 901 is a control unit that performs overall control of the MFP 900. The NB 903 is a bridge for connecting the CPU 901 to the MEM-P 902, the SB 904, and the AGP bus 921, and includes a memory controller for controlling reading and writing with respect to the MEM-P 902, a Peripheral Component Interconnect (PCI) master, and an AGP target.

The MEM-P 902 includes a ROM 902a, which is a memory for storing programs and data for implementing functions of the controller 910, and a RAM 902b, which is used for expanding programs or data and which is used as a rendering memory at the time of memory printing, and the like. Note that the programs stored in the RAM 902b may be provided by being recorded in a computer-readable recording medium such as a Compact Disk Read-Only Memory (CD-ROM), a CD recordable (CD-R), or a digital versatile disc (DVD) in a file of an installable format or an executable format.

The SB 904 is a bridge for connecting the NB 903 to PCI devices and peripheral devices. The ASIC 906 is an integrated circuit (IC) for image processing applications having hardware elements for image processing, and serves as a bridge connecting the AGP bus 921, a PCI bus 922, the HDD controller 908, and the MEM-C 907, respectively. The ASIC 906 includes a PCI target, an AGP master, an arbitrator (ARB) that forms the core of the ASIC 906, a memory controller that controls the MEM-C 907, a plurality of Direct Memory Access Controllers (DMACs) that rotates image data by a hardware logic, etc., and a PCI unit that performs data transfer between the scanner unit 931 and the printer unit 932 via the PCI bus 922. Note that the ASIC 906 may be connected to an interface of the USB or an interface of the Institute of Electronic and Electronic Engineers 1394 (IEEE 1394).

The MEM-C 907 is a local memory used as a copy image buffer and a code buffer. The HD 909 is a storage for storing image data, storing font data used for printing, and storing forms. The HD 909 controls the reading or writing of data with respect to the HD 909 according to the control of the CPU 901. The AGP bus 921 is a bus interface for a graphics accelerator card proposed for increasing the speed of graphics processing, and by directly accessing the MEM-P 902 with high throughput, the graphics accelerator card can be made faster.

The near field communication circuit 920 includes a near field communication unit 920a. The near field communication circuit 920 is a communication circuit of Near Field Communication (NFC), Bluetooth (registered trademark), etc.

The engine control unit 930 is configured by, for example, a scanner unit 931 and a printer unit 932. The operation panel 940 includes a panel display unit 940a, such as a touch panel, for displaying the present setting value, a selection screen, a start key for accepting an instruction to start copying and the like, and for accepting input from an operator; and operation buttons 940b configured by a numeric pad for accepting a setting value of an image forming condition such as a density setting condition. The controller 910 controls the entire MFP 900 and controls, for example, rendering, communication, input from the operation panel 940, and the like. The scanner unit 931 or the printer unit 932 includes an image processing portion such as error diffusion or gamma conversion.

Note that in the MFP 900, by using an application switching key of the operation panel 940, it is possible to sequentially switch and select among a document box function, a copy function, a printer function, and a fax function. When the document box function is selected, the document box mode is set, when the copy function is selected, the copy mode is set, when the printer function is selected, the printer mode is set, and when the fax function is selected, the fax mode is set.

The network I/F 950 is an interface for performing data communication by using the network N1. The near field communication circuit 920, the network I/F 950, and the like are electrically connected, for example, to the ASIC 906 via the PCI bus 922.

### <Service Provided by Service Providing System>

A service provided by the service providing system 10 according to the present embodiment will now be described. Hereinafter, the device 20 will be described as an image forming apparatus.

In the present embodiment, a service of performing an OCR process on an electronic file (image file) generated by scanning a document in the device 20, translating the electronic file into a predetermined language, transmitting the electronic file by e-mail, and uploading the electronic file, is referred to as a “scan translation service”. In the present embodiment, a case where the service providing system 10 provides the scan translation service will be described.

Here, in order for the service providing system 10 to provide the scan translation service, it is necessary to register an application (application information 1000 to be described later) for the device 20 to use the scan translation service, in the service providing system 10.

Accordingly, a case in which the PC terminal 30 registers an application for using the scan translation service will be described in the present embodiment. However, the services provided by the service providing system 10 are not limited thereto. Note that a process of the case where the device 20 uses an application for using the scan translation service, is publicly known as described, for example, in Japanese Unexamined Patent Application Publication No. 2018-14079, and, therefore, descriptions thereof will be omitted.

### <Functional Configuration>

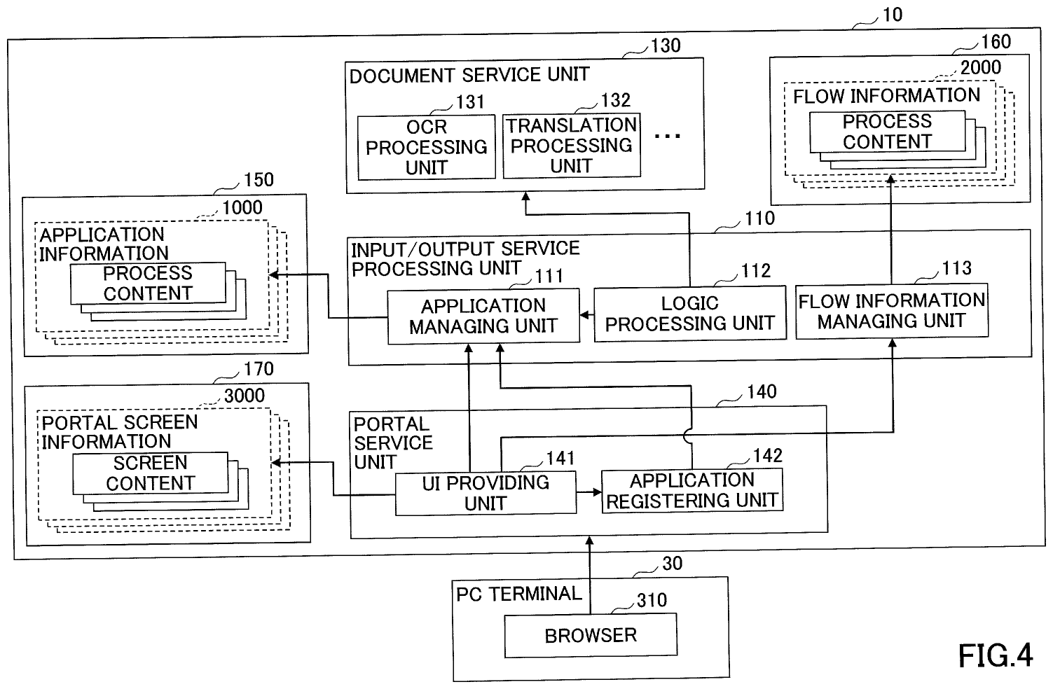

FIG. 4 is a diagram illustrating an example of a functional configuration of the information processing system according to the present embodiment. The PC terminal 30 illustrated in FIG. 4 includes a browser 310 that functions as a screen rendering unit by being executed by, for example, the CPU 501. The user of the PC terminal 30 can use the browser 310 to register, in the service providing system 10, an application for using various services such as the “scan translation service”. In FIG. 4, the device 20 is omitted.

The service providing system 10 illustrated in FIG. 4 includes an input/output service processing unit 110, a document service unit 130, and a portal service unit 140. Each of these functional units is implemented by a process that the CPU 501 is caused to execute by one or more programs installed in the service providing system 10.

Further, the service providing system 10 includes an application information storage unit 150, a flow information storage unit 160, and a portal screen information storage unit 170. Each of these storage units can be implemented by using the HD 504. Note that at least one of these storage units may be implemented by using a storage device and the like connected to the service providing system 10 via the network N1.

The input/output service processing unit 110 performs a process related to the service provided by the service providing system 10. The input/output service processing unit 110 executes a flow based on the application information 1000, flow information 2000, and input information from the device 20. The input/output service processing unit 110 of FIG. 4 includes an application managing unit 111, a logic processing unit 112, and a flow information managing unit 113.

The application managing unit 111 manages the application information 1000 stored in the application information storage unit 150. Note that the application managing unit 111 manages the application information 1000 by associating a screen definition and a process content with an application ID and the like. Further, the application managing unit 111 returns the application information 1000 in response to a request from the logic processing unit 112.

Further, the application managing unit 111 stores the application information 1000 in the application information storage unit 150 in response to a request from the portal service unit 140. Accordingly, the application information 1000 (application) that provides a service is registered in the service providing system 10.

The flow information managing unit 113 manages the flow information 2000 stored in the flow information storage unit 160. Note that the flow information 2000 is information defining, as a flow, the order of executing one or more programs executing each process in a series of processes implementing a service provided by the application information 1000.

The logic processing unit 112 acquires the application information 1000 from the application managing unit 111. The logic processing unit 112 executes a series of processes (flow) for implementing a service provided by the application information 1000, based on the application information 1000. Accordingly, the service providing system 10 according to the present embodiment can provide various services such as the “scan translation service”.

The document service unit 130 executes a predetermined process included in a series of processes (flow) for implementing a service provided by the application information 1000. Here, the document service unit 130 includes an OCR processing unit 131 and a translation processing unit 132.

The OCR processing unit 131 performs an OCR process on an electronic file. The translation processing unit 132 executes a text translation process of translating a text into a predetermined language. The document service unit 130 may include various other functional units, such as an e-mail transmitting unit for creating an e-mail to which an electronic file is attached and delivering this e-mail to a specified e-mail address, a compression/decompression processing unit for compressing or decompressing an electronic file, a data format converting unit for converting a data format of an electronic file, and the like.

The portal service unit 140 performs a process for the user to register an application by using the browser 310 of the PC terminal 30. Here, the portal service unit 140 includes a user interface (UI) providing unit 141 and an application registering unit 142.

The UI providing unit 141 provides screen data of a screen to be displayed on the browser 310 in response to a request from the browser 310. A screen to be displayed on the browser 310 includes the top screen of a portal, a flow creation screen, a parameter setting screen, and the like. Further, the UI providing unit 141 acquires the application information 1000, the flow information 2000, and portal screen information 3000 necessary for providing screen data. Note that a portal is a website where an application and the like can be registered by using the browser 310. The portal screen information 3000 is information that defines various screens, such as the top screen of a portal (portal top screen), a flow creation screen, a parameter setting screen, and the like. The portal screen information 3000 is information in which various screens are defined by the browser 310, such as Hyper Text Markup Language (HTML), eXtensible Markup Language (XML), cascade style sheets (CSS), JavaScript, and the like.

As described above, the PC terminal 30 displays various screens including a portal top screen, a flow creation screen, a parameter setting screen, and the like based on portal top screen data, flow creation screen data, and parameter setting screen data, that have been received. Therefore, the user of the PC terminal 30 can perform an operation of registering an application (the application information 1000) from various screens displayed in the browser 310.

The application registering unit 142 requests the application managing unit 111 to register an application (the application information 1000) in response to a request from the UI providing unit 141. That is, when an operation of registering an application is performed, the application registering unit 142 requests the application managing unit 111 to register the application. The application managing unit 111 stores the application information 1000 in the application information storage unit 150.

For example, the application information 1000 that provides the scan translation service includes flow information in which a series of processes for implementing the scan translation service is defined, and parameter setting information in which various parameter settings of the application information 1000 are defined. Note that the input/output service processing unit 110, the document service unit 130, the portal service unit 140 and the like may be respectively implemented by different information processing apparatuses.

### <Details of Process>

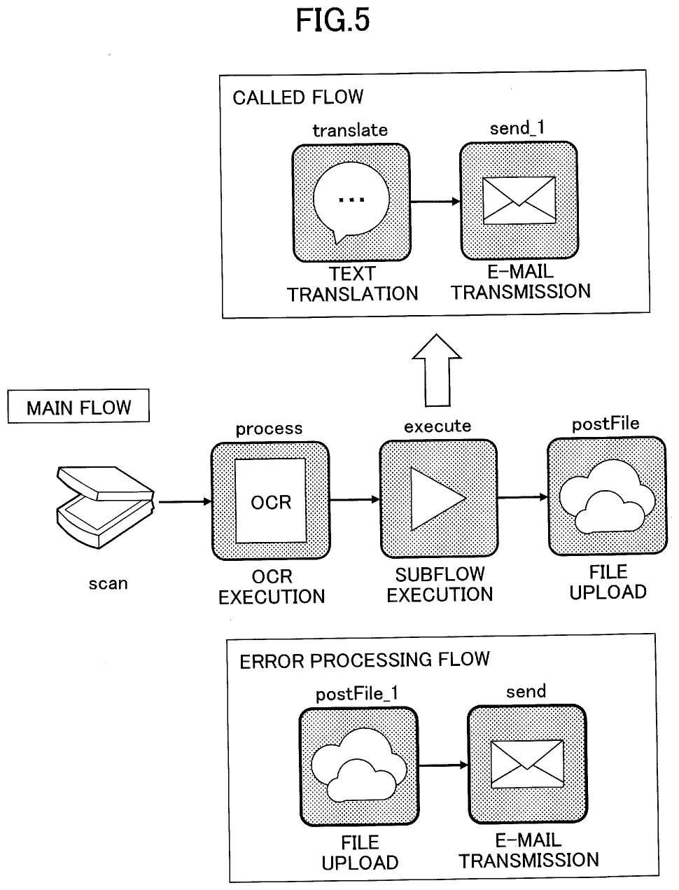

Next, details of the process of the information processing system 1 according to the present embodiment will be described. First, the process of registering the scan translation application in the service providing system 10 by a user of the PC terminal 30 will be described. Here, an example of registering the scan translation application in which the flow of FIG. 5 is set, will be described.

FIG. 5 is an example of a diagram of flows that are set in a scan translation application. The flows of FIG. 5 include three flows: a main flow; a called flow; and an error processing flow. The called flow is a flow called in the main flow. The error processing flow is a flow that is called when an error occurs.

The called flow and the error processing flow are examples of a flow (a second flow) associated with the main flow (a first flow). In the scan translation application of FIG. 5, in the main flow, scanning is executed by “scan” and the scan file is subjected to OCR processing by “OCR execution”, and “subflow execution” is performed with respect to the result of the OCR process to execute the called flow.

By “text translation” in the called flow, the result of the OCR process is subjected to text translation. By “e-mail transmission” in the called flow, the result of the text translation is transmitted by e-mail. When the called flow is ended, in “file upload” in the main flow, the scan file is uploaded to the upload destination.

When an error occurs in any of the processes in the main flow, the error processing flow is executed. When an error occurs in a process of the called flow, “subflow execution” of the main flow becomes an error. In “file upload” of the error processing flow, the scan file is uploaded to the upload destination. In “e-mail transmission” in the error processing flow, the scan file is transmitted by e-mail.

In the scan translation application in which the flows illustrated in FIG. 5 are set, items such as the transmission destination of “e-mail transmission” in the called flow and the error processing flow and the like, need to be set in the parameter setting information described below, as parameters to be input by the user. Note that the parameters are set on a per-component basis such as “OCR execution” and “text translation” displayed by icons in FIG. 5.

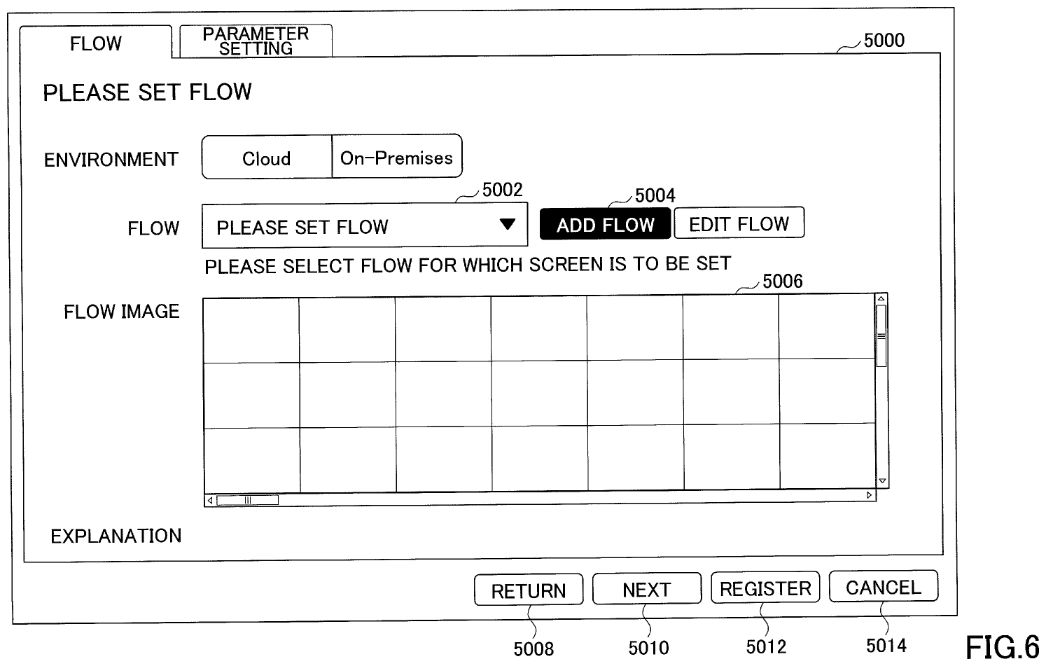

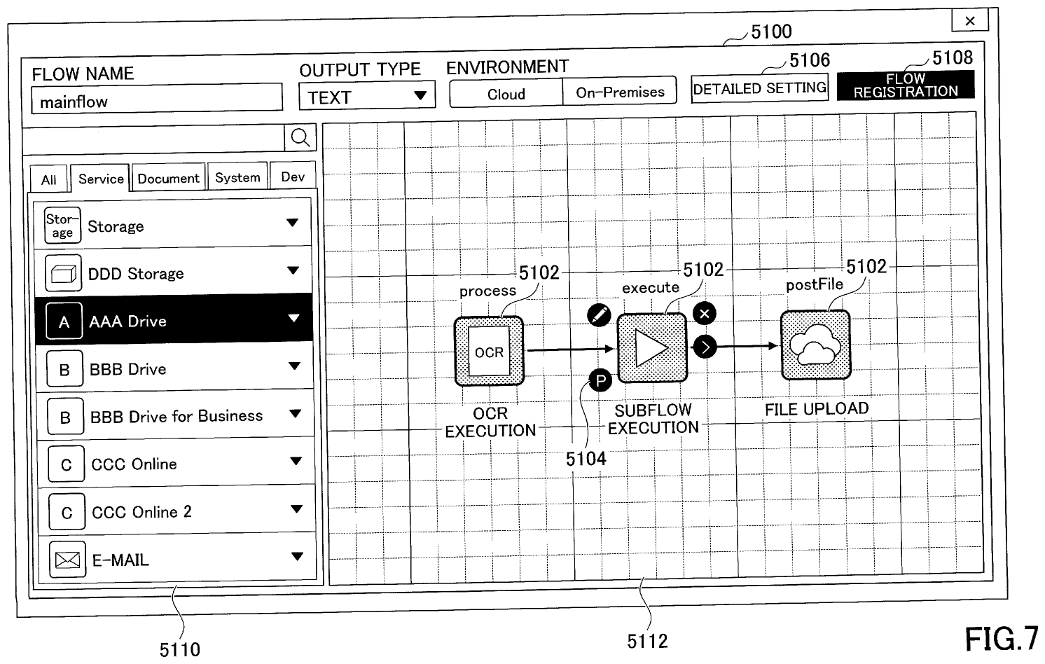

Next, a process overview from the flow creation to the registration of the scan translation application will be described with reference to the screen images of FIGS. 6 to 11. FIGS. 6 to 11 illustrate examples of screen images displayed in the browser 310 of the PC terminal 30. FIG. 6 is an image diagram illustrating an example of a flow setting screen 5000. FIG. 7 is an image diagram illustrating an example of a flow creation screen 5100.

The user displays the flow creation screen 5100 as illustrated in FIG. 7, by pressing (for example, clicking) a flow addition button 5004 of the flow setting screen 5000 in FIG. 6. In the flow creation screen 5100, the user can create a flow by selecting a component 5102 from a component selection field 5110 and arranging the component 5102 in a component arrangement field 5112, and pressing a flow registration button 5108. In this manner, the user creates the called flow and the error processing flow of FIG. 5. Further, the user performs an operation of pressing the flow addition button 5004 of the flow setting screen 5000 to display the flow creation screen 5100 of FIG. 7, and arranges the component 5102 as in the component arrangement field 5112 of FIG. 7.

Subsequently, the user performs an operation of pressing a parameter setting button 5104 of the component 5102 in the flow creation screen 5100 to display a screen, and sets a called flow with respect to the main flow from the displayed screen. Further, the user performs an operation of pressing a detailed setting button 5106 of the flow creation screen 5100 to display a screen, and sets an error processing flow with respect to the main flow from the displayed screen. In this manner, the user creates the main flow of FIG. 5.

After creating the main flow of FIG. 5, the user can perform an operation of selecting the main flow in a flow selection field 5002 of the flow setting screen 5000 of FIG. 6, to display a flow image of the main flow, the called flow, and the error processing flow in a flow image field 5006.

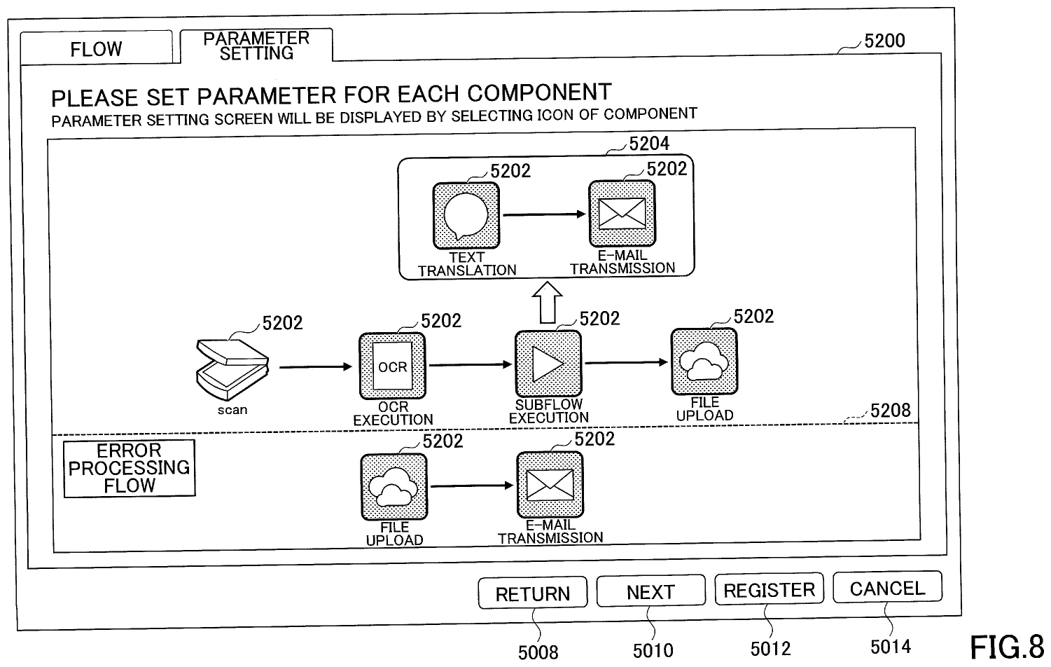

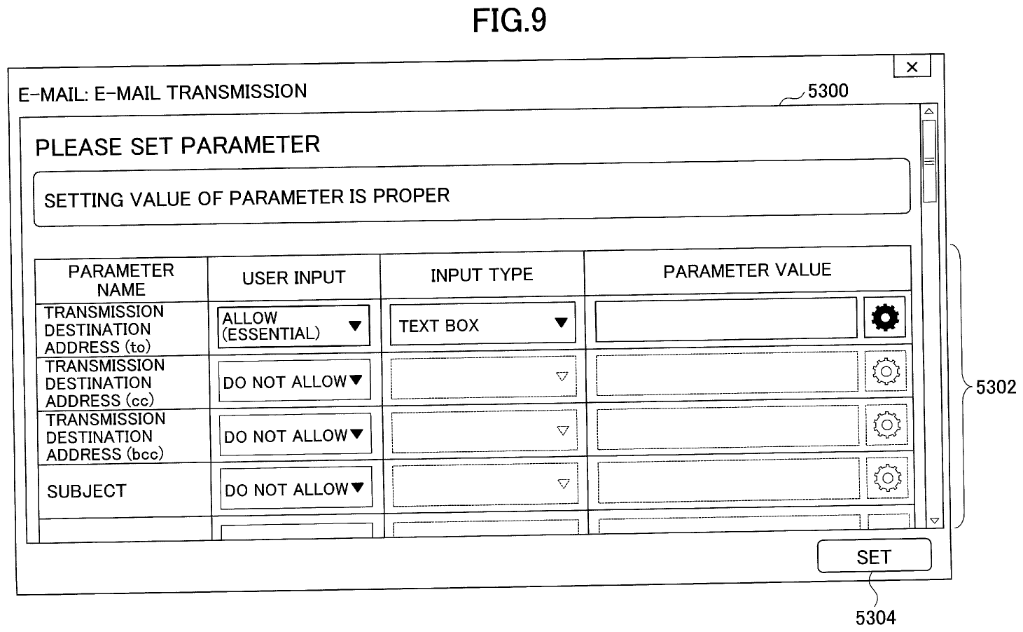

In this state, by performing an operation of switching from a “flow” tab to a “parameter setting” tab, the user can display a component selection screen 5200 of FIG. 8. FIG. 8 is an image diagram illustrating an example of the component selection screen 5200. The user can perform an operation of selecting a component 5202 of the component selection screen 5200 to display a parameter setting screen 5300 as illustrated in FIG. 9 for setting the parameters of the component 5202.

FIG. 9 is an image diagram illustrating an example of the parameter setting screen 5300. Note that FIG. 9 is an example of the parameter setting screen 5300 in a case where the component 5202 of “e-mail transmission” of the called flow of the component selection screen 5200 of FIG. 8 has been selected by the user. From a parameter setting field 5302 in the parameter setting screen 5300 of FIG. 9, the user can input parameters of “e-mail transmission” of the called flow and press a set button 5304, to set the parameters.

The user performs an operation of sequentially selecting the components 5202 of the component selection screen 5200 to set the parameters of the components 5202 that configure the main flow, the called flow, and the error processing flow, from the parameter setting screen 5300 of FIG. 9.

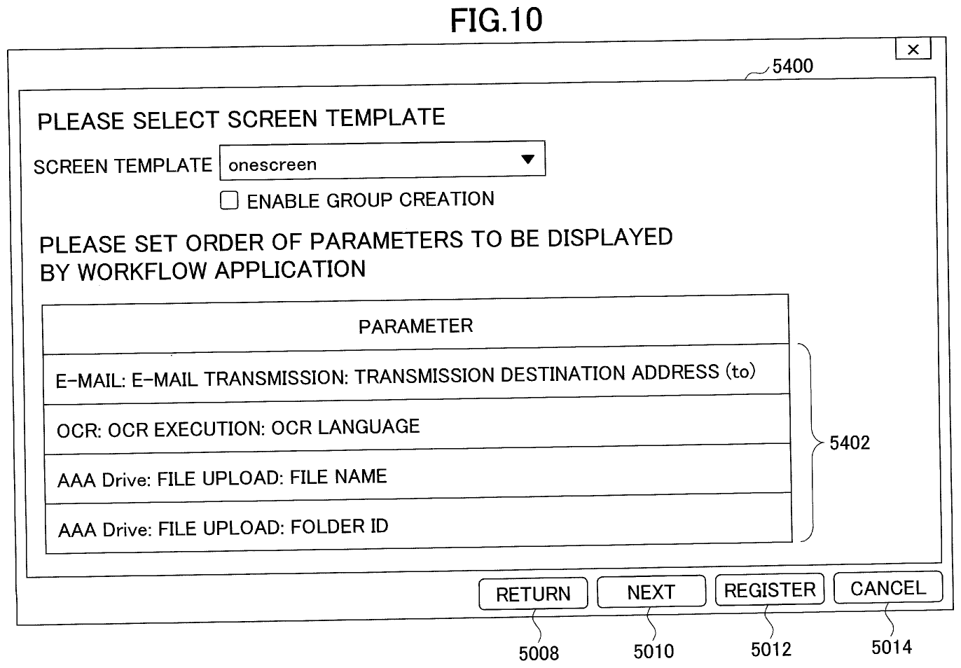

After creating the flows and setting the parameters, the user displays a parameter order setting screen 5400 of FIG. 10 by pressing a next button 5010 in FIG. 6 or FIG. 8. FIG. 10 is an image diagram illustrating an example of the parameter order setting screen 5400 of the scan translation application. The parameter order setting screen 5400 is an image diagram of an example of a screen for setting the order of the parameters to be displayed on the screen of the scan translation application. The user can set the order of the parameters displayed in a parameter order setting field 5402 of the parameter order setting screen 5400 by drag-and-drop, etc.

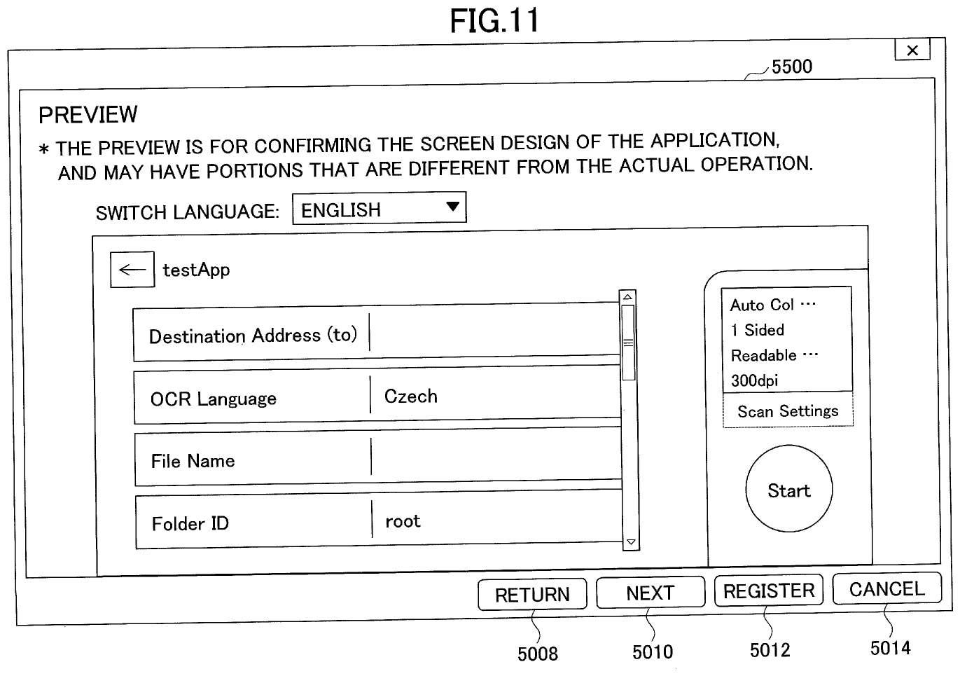

After setting the order of the parameters, the user presses the next button 5010 to display a preview screen 5500 of FIG. 11. FIG. 11 is an image diagram illustrating an example of the preview screen 5500 of the scan translation application. By viewing the preview screen 5500, the user confirms the screen design of the scan translation application. When there is no problem with the screen design of the scan translation application, the user presses a registration button 5012, and the registration of the scan translation application is completed.

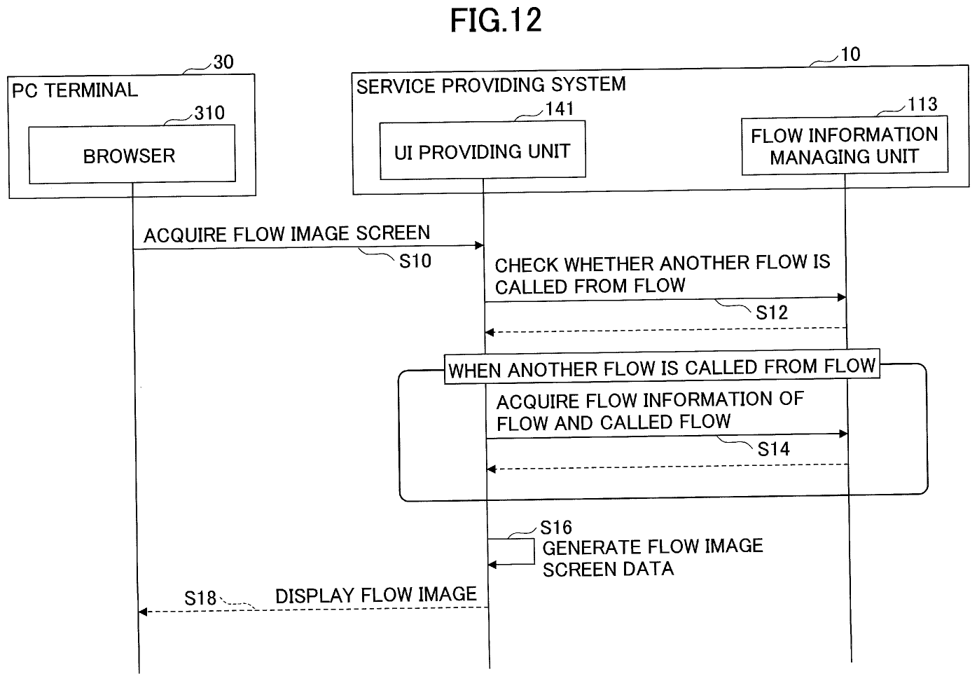

The process of displaying a flow in the flow image field 5006 of FIG. 6 or the process of displaying a flow in the component selection screen 5200 of FIG. 8 is performed, for example, by procedures of a sequence diagram illustrated in FIG. 12. FIG. 12 is a sequence diagram illustrating an example of a flow display process. Here, an example of the flow of FIG. 5 will be described.

In step S10, the browser 310 of the PC terminal 30 transmits a request to acquire flow image screen data to the UI providing unit 141 of the service providing system 10. In step S12, the UI providing unit 141 transmits, to the flow information managing unit 113, a check request to check whether another flow is called from the main flow of FIG. 5.

The flow information managing unit 113 refers to the flow information 2000 stored in the flow information storage unit 160 and checks whether there is a process of calling another flow in the main flow or whether an error processing flow is set. When there is no process of calling another flow in the main flow and an error processing flow is not set, the flow information managing unit 113 determines that another flow is not called from the main flow. Otherwise, the flow information managing unit 113 determines that another flow is called from the main flow. The flow information managing unit 113 transmits the check result to the UI providing unit 141.

When another flow is called from the main flow, in step S14, the UI providing unit 141 acquires, from the flow information managing unit 113, flow information of the main flow and flow information of the called flow and the error processing flow that are other flows called from the main flow.

Proceeding to step S16, when another flow is called from the main flow, the UI providing unit 141 generates flow image screen data in which the main flow and the called flow and the error processing flow that are other flows called from the main flow, are displayed. When another flow is not called from the main flow, the UI providing unit 141 generates flow image screen data in which the main flow is displayed.

Proceeding to step S18, the UI providing unit 141 transmits the flow image screen data generated in step S16 to the browser 310 of the PC terminal 30 and causes the browser 310 to display a flow image.

As described above, in the information processing system 1 according to the present embodiment, a flow image of the main flow, the called flow, and the error processing flow can be displayed on the component selection screen 5200 of FIG. 8. Further, in the information processing system 1 according to the present embodiment, by performing the operation of selecting the component 5202 in the component selection screen 5200 of FIG. 8, the parameters of the main flow, the called flow, and the error processing flow can be set.

Accordingly, in the information processing system 1 according to the present embodiment, on a user interface similar to a user interface for setting the parameters of the flow (for example, the main flow) set in the application, it is possible to set the parameters of another flow (for example, the called flow or the error processing flow) called from the flow (for example, the main flow) set in the application.

As described above, in the information processing system 1 according to the present embodiment, the user can use the PC terminal 30 to create a main flow, a called flow, and an error processing flow, and set parameters, and, therefore, the application information 1000 can be easily registered. Further, in the information processing system 1 according to the present embodiment, the user can use the device 20 to use various services provided by the application registered in the service providing system 10.

### Other Embodiments

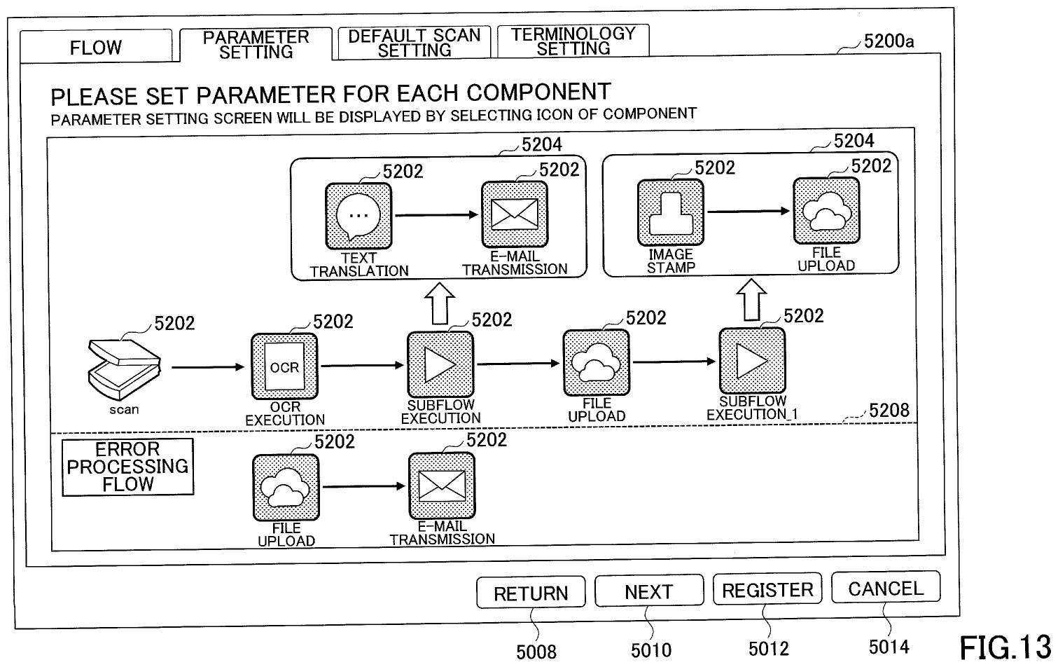

In the component selection screen 5200 illustrated in FIG. 8, an example in which there is one called flow (sub-flow) is indicated; however, as in a component selection screen 5200a illustrated in FIG. 13, there may be a plurality of called flows 5204. FIG. 13 is an image diagram illustrating an example of the component selection screen 5200a. The user can perform an operation of selecting the component 5202 in the component selection screen 5200a to display the parameter setting screen 5300 as illustrated in FIG. 9 for setting the parameters of the component 5202, similar to the component selection screen 5200 illustrated in FIG. 8.

Further, in the component selection screen 5200 illustrated in FIG. 8 and the component selection screen 5200a illustrated in FIG. 13, an example in which there is one error processing flow is indicated; however, there may be a plurality of error processing flows. For example, when the error processing flow to be executed differs according to the operation in which an error has occurred, or when the error processing flow to be executed differs according to the type of error that has occurred, there may be a plurality of error processing flows.

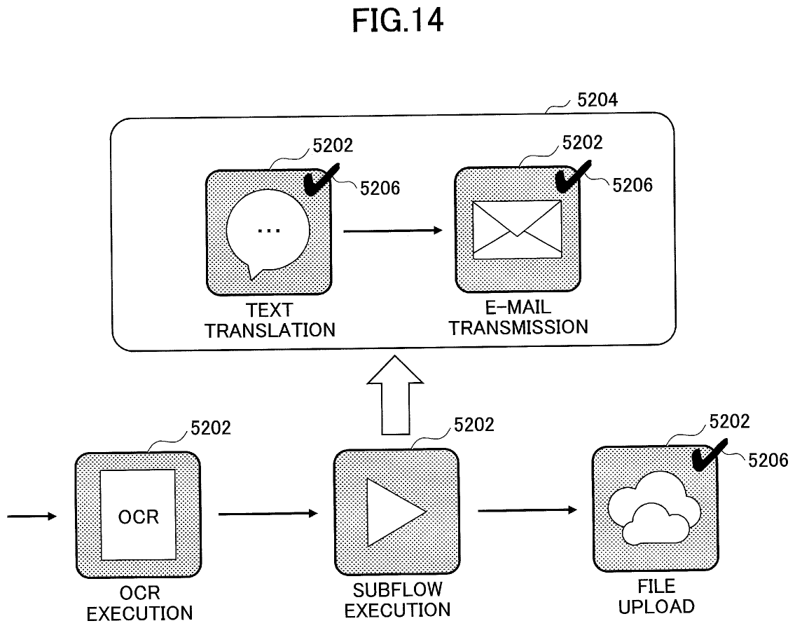

Further, in the component selection screen 5200 illustrated in FIG. 8 and the component selection screen 5200a illustrated in FIG. 13, a check mark 5206 may be displayed with respect to the component 5202 for which parameters have already been set, as illustrated in FIG. 14. FIG. 14 illustrates an example of the component 5202 for which the check mark 5206 is displayed.

As illustrated in FIG. 14, by displaying the check mark 5206 on the component 5202 for which parameters have already been set, it is possible to easily distinguish between the component 5202 for which parameters have already been set and the component 5202 for which parameters have not been set.

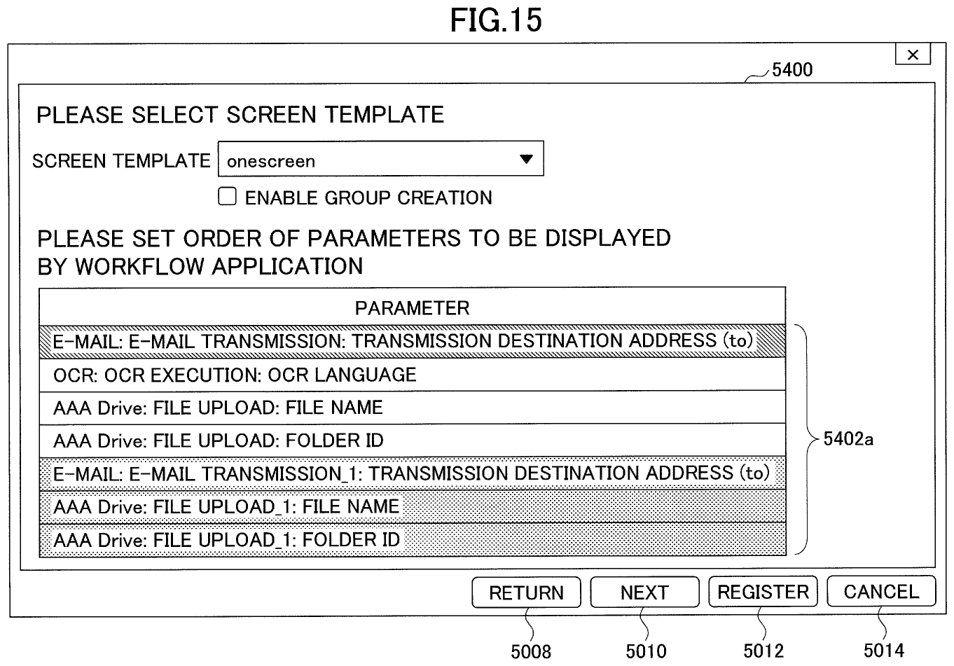

Further, the parameter list displayed in the parameter order setting field 5402 in the parameter order setting screen 5400 of FIG. 10 may be displayed as illustrated in FIG. 15. FIG. 15 is an image diagram illustrating an example of the parameter order setting screen 5400 of the scan translation application. In a parameter order setting field 5402a in the parameter order setting screen 5400 of FIG. 15, the parameters of the main flow, the called flow, and the error processing flow are respectively displayed in different colors so as to be distinguishable.

As illustrated in FIG. 15, by having the parameters of the main flow, the called flow, and the error processing flow respectively displayed in different colors so as to be distinguishable, it is possible to easily identify the flow to which a parameter belongs.

In the component selection screen 5200 illustrated in FIG. 8 and the component selection screen 5200a illustrated in FIG. 13, the called flow 5204 is enclosed in a red frame and the error processing flow is displayed in a section formed with a dashed line 5208. Accordingly, in the component selection screen 5200 illustrated in FIG. 8 and the component selection screen 5200a illustrated in FIG. 13, the main flow, the called flow 5204, and the error processing flow can be displayed so as to be distinguishable, so that it is possible to easily identify the kind of flow.

The present invention is not limited to the above specifically disclosed embodiments, and various modifications and variations are possible without departing from the scope of the claims. The functions of each of the embodiments described above may be implemented by one or more processing circuits. As used herein, a “processing circuit” includes a processor programmed to execute each function by software such as a processor implemented in an electronic circuit; or devices such as an Application Specific Integrated Circuit (ASIC), a digital signal processor (DSP), a field programmable gate array (FPGA), and a conventional circuit module, designed to execute each function as described above.

According to one embodiment of the present invention, parameters of a second flow that is associated with a first flow, can be set.

The information processing system, the information processing apparatus, and the method are not limited to the specific embodiments described in the detailed description, and variations and modifications may be made without departing from the spirit and scope of the present invention.

What is claimed is:

1. An information processing system comprising:
at least one device including a browser; and
a service providing system including at least one information processing apparatus, wherein
the service providing system includes:
a flow information manager configured to manage, for each application that executes a series of processes using electronic data,
first flow information defining an order of executing one or more programs configured to execute each process included in the series of processes of a first flow,
second flow information defining an order of executing the one or more programs configured to execute each process included in the series of processes of a second flow associated with the first flow, and
parameter setting information for setting a parameter used for executing each of the one or more programs; and
a user interface provider configured to provide, to the at least one device, flow image screen data based on
the first flow information and the second flow information, and
parameter setting screen data based on the parameter setting information of the first flow information and the second flow information, and wherein
the at least one device includes:
a screen renderer configured to
display a flow image screen based on the provided flow image screen data and to display a parameter setting screen based on the provided parameter setting screen data, and
accept, from a user at the parameter setting screen, a setting operation for setting the parameter of the first flow information and the second flow information.

2. The information processing system according to claim 1, wherein
the user interface provider provides, to the at least one device upon detecting that the second flow associated with the first flow is present, the flow image screen data based on the first flow information and the second flow information, and the parameter setting screen data based on the parameter setting information of the first flow information and the second flow information, and
the user interface provider provides, to the at least one device upon detecting that the second flow associated with the first flow is not present, the flow image screen data based on the first flow information, and the parameter setting screen data based on the parameter setting information of the first flow information.

3. The information processing system according to claim 1, wherein the user interface provider displays, with respect to each of the one or more programs, information indicating whether the parameter used for executing each of the one or more programs has already been set.

4. The information processing system according to claim 1, wherein the user interface provider generates the parameter setting screen data such that the screen renderer displays the parameter of the first flow information and the parameter of the second flow information in a visually distinguishable manner from each other.

5. The information processing system according to claim 1, wherein the user interface provider generates the parameter setting screen data such that the screen renderer displays the first flow information and the second flow information in a visually distinguishable manner from each other.

6. An information processing apparatus connected, via a network, to at least one device including a browser, the information processing apparatus comprising:
a flow information manager configured to manage, for each application that executes a series of processes using electronic data,
first flow information defining an order of executing one or more programs configured to execute each process included in the series of processes of a first flow,
second flow information defining an order of executing the one or more programs configured to execute each process included in the series of processes of a second flow associated with the first flow, and
parameter setting information for setting a parameter used for executing each of the one or more programs; and
a user interface provider configured to provide, to the at least one device,
flow image screen data based on the first flow information and the second flow information, and
parameter setting screen data based on the parameter setting information of the first flow information and the second flow information, and to
cause the at least one device to
display a flow image screen based on the flow image screen data and to display a parameter setting screen based on the parameter setting screen data, and
accept, from a user at the parameter setting screen, a setting operation for setting the parameter of the first flow information and the second flow information.

7. A method executed by an information processing system, the information processing system including
at least one device including a browser, and
a service providing system including at least one information processing apparatus, the method comprising:
managing, by the service providing system, for each application that executes a series of processes using electronic data,
first flow information defining an order of executing one or more programs configured to execute each process included in the series of processes of a first flow,
second flow information defining an order of executing the one or more programs configured to execute each process included in the series of processes of a second flow associated with the first flow, and
parameter setting information for setting a parameter used for executing each of the one or more programs;
providing to the at least one device by the service providing system,
flow image screen data based on the first flow information and the second flow information, and
parameter setting screen data based on the parameter setting information of the first flow information and the second flow information;
displaying, by the at least one device, a flow image screen based on the provided flow image screen data and displaying a parameter setting screen based on the provided parameter setting screen data; and
accepting, from a user at the parameter setting screen by the at least one device, a setting operation for setting the parameter of the first flow information and the second flow information.
